(19) United States
(12) Patent Application Publication
(10) Pub. No.: US 2020/0056738 A1
(43) Pub. Date: Feb. 20, 2020

(54) UNIVERSAL COLLABORATIVE ROBOT MOUNTING PEDESTAL SYSTEM AND METHOD

(71) Applicant: All Axis Robotics, LLC, Dallas, TX (US)

(72) Inventors: Gary Kuzmin, Plano, TX (US); David Perkowski, Plano, TX (US); Uriel Rodriguez, Denton, TX (US); Michael Mandry, Bend, OR (US); Cristian Almendariz, Mansfield, TX (US)

(21) Appl. No.: 16/543,469

(22) Filed: Aug. 16, 2019

Related U.S. Application Data
(60) Provisional application No. 62/719,029, filed on Aug. 16, 2018.

(51) Int. Cl. F16M 7/00; B25J 19/00; F16B 2/06

(52) U.S. Cl. CPC F16M 7/00; F16B 2/065; B25J 19/00

(57) ABSTRACT

Systems and methods to facilitate the use of collaborative robots to tend metal fabrication equipment are provided. In one embodiment, a universal mount is provided that can be installed on a pedestal to secure a collaborative robot in a designated location. In various embodiments, the universal mount may provide the ability to move the pedestal that holds the collaborative robot away from a machine access door for redeployment or to allow machine maintenance or part inspection.

### CROSS-REFERENCE TO RELATED APPLICATIONS

This patent application claims priority to U.S. Prov. Pat. App. Ser. No. 62/719,029, filed Aug. 16, 2018, which is hereby incorporated by reference for all purposes.

### BACKGROUND

### Technical Field

This invention relates in general to the field of workpiece fabrication, and more particularly, but not by way of limitation, to systems and methods to facilitate the use of collaborative robots to tend metal fabrication equipment.

### Background

Throughout history, the goal of manufacturers, regardless of the industry, has always been to find improved means to reduce production cycle time, increase employee output, improve manufacturing efficiency, and improve customer on-time delivery and quality levels while maintaining and improving profitability. Nonetheless, these goals are only achievable to those entrepreneurs willing to make capital investments into their manufacturing operations. Now, more than ever, as the labor shortages spread throughout industrialized nations, impacting productivity and raising wages, automated implementation has become increasingly important in manufacturing.

Until the 1940's, manufacturing processes often involved a person known as a master craftsman machinist moving bars of metal under a spinning tool that was manipulated by a hand crank. It was an iterative process where the machinist would remove some material, measure the part and if not correct, repeat the process. This method of metal fabrication was a labor intensive process and took a skilled craftsman to create parts to the correct specification. To succeed in this line of work, as these operations were all done by hand and eye, individuals were trained for several years as an apprentice under the auspices of a craftsman, which is a very expensive process. Those that were successful became machinists, those that were not, became tool setters and operators.

The next major step to improving efficiencies in the metal fabrication process was the introduction of the Computer Numerical Controls (CNC) machines. These machines were developed to replicate the skill of a master craftsman machinist in a machine to help improve manufacturing efficiency. As we know today, that investment effort resulted in a milling machine (generically known as a CNC machine today) that was capable of reliably building complex fabricated parts with extreme precision and repeatability over manual machining methods. While not eliminating expert craftsmen altogether, these CNC machines could now simultaneously duplicate on a larger scale what one master craftsman could do. No longer would machines sit idle for the lack of highly skilled machinists to run the machines. CNC machines could store programs that were once only in the mind of a machinist and those programs could be accessed by multiple people and machines.

These new CNC machines required a new emerging skillset of programmers to program the machines. The machinists often became both the programmer of the machine and the operator of the machine. The machine operators were required to tend the machine to load and unload parts as well as check the parts for compliance to tolerances. The result of using CNC machines versus the previous manufacturing methods resulted in a dramatic reduction of normal production times.

Over the next 50 years, as machine building methods and programs to operate CNC machines evolved, the introduction of computer-aided manufacturing (CAM) and digital motor controls improved the ability to achieve far more complex and accurate machining. The conversion to digital controls eventually resulted in the ability to program computer devices with multiple nodes to control the machine tooling process, resulting in rapid advances in shop productivity by automating the highly technical and labor intensive processes and eventually leading to the introduction of multiple levels of automation.

The next evolutionary step was the introduction of automation in the form of a machine tool pallet changer (also known as a machine bed). On each CNC machine, there is often a single machine bed or pallet where the part to be machined is secured with a machine vice. The machine vice is precisely positioned so the machine knows exactly where the raw material to be machined is located. Because of improvements in positioning technology, multiple identically configured machine beds or pallets are often added to the machine as an option from the manufacture or added by a company that specializes in automatic pallet changers (APC's).

The concept behind the APC's is that additional identically configured machine pallets (the number depends on the design of the machine) can be queued up in a specially designed machine that stores/queues them in a indexed carousel. When the CNC machine program making the part is completed, a signal is sent to the APC apparatus and the entire machine bed (or pallet) on the machine is replaced with a fresh, identical pallet and part to be machined without the intervention of a machinist. While the machine is running the new part, an operator is still required to be at the machine to remove the completed part and replace it with a new blank. While it does not take a skilled machinist to replace the part, it does require an operator to tend the machine to remove the finished part and load a new part into the pallet vice for the next cycle.

From an operation perspective, one of the physical advantages to the APC system is that they are integrated into the existing frame (either by bolting or welding) of the CNC machine. This allows the two mechanized systems to be properly aligned which permits seamless, trouble-free transfers. Because the APC systems are generally located away from the spindle access port of the CNC machine, the operators can freely access the part being machined and perform routine maintenance duties such as changing tools and verifying dimensions without having to move equipment and re-align the transfer equipment. APCs are considered safe for the workplace as they are fully enclosed and interlocked to prevent the operator from being unnecessarily exposed to danger from the rotating mechanism of the machine.

The decision to incorporate an APC into a machine depends on the production volume of the part being manufactured and the manufacturing floor space available to be allocated for the additional sub-system. Because of the cost of these APCs, the return on investment is generally recovered for those parts that have either long production cycle times or high production volumes. Generally, manufacturing parts with short or low volume production runs is unable to take full advantage of the APC units due to the setup time required to prepare the part for machining.

Industrial robots, again because of the development of digital controls, were also developed during the same time period as the APC. Industrial robots were the first automated systems designed to mimic and replace humans for monotonous and mundane manufacturing tasks. Industrial robot advantages have been especially proficient at cutting costs, increasing productivity, improving quality, and taking over dangerous or harmful tasks such as moving or positioning heavy parts and casting, welding, and bending.

Deployments of industrial robots require significant financial and human resource investments. These systems can be significantly more expensive than APCs. They also require hiring more skilled staff as the programming of the industrial robots is neither intuitive nor similar to CAM programming of a CNC machine. In addition, industrial robots have multiple potential safety hazards requiring more safeguards to be considered during both programming and deployment. The physical size of industrial robots, their high speed and torque, and their lack of built-in force, touch, or pressure sensors all create a potential safety concern in a working environment if it is closely coupled with human interaction. As long as these safety concerns are addressed, the productivity advantages gained by these machines can be significant, but usually only when applied to a high volume part. In a low-volume, high-mix manufacturing environment, this setup is often not practical.

In another configuration, CNC machine tool makers have tried to integrate non-APC automation into their equipment. Internal grippers have been integrated and can be called out by the CAM program to remove completed parts, but their flexibility is very limited in a high-mix, low-volume production environment. These solutions only address the removal of a completed part and not the placing of a raw blank into the machine at the beginning of the machine cycle.

Recently, a new generation of robots, known as collaborative robots, has become available to the marketplace. The introduction of collaborative robots is changing all the preconceived thoughts about the ease to introduce robotics into both high-volume, low-mix and high-mix, low-volume applications. The main feature of collaborative robots is their ability to work safely alongside humans. Therefore, human-robot collaboration is the new wanted characteristic for robots. Some collaborative robots can be taught very easily by demonstration, instead of requiring a deep knowledge in programming. Thus, they can be implemented very easily and brought online fast, since no complicated setup (e.g., the installation of protective fences or guards around the robot) is needed.

Large robots, because of their weight and the torque that they generate, are often bolted directly to the factory floor in order to ensure they hold alignment. While bolting to the floor ensures alignment, the robot is fixed in its location and cannot be moved or redeployed. To raise smaller robotic arms to the correct height for tending a CNC machine, smaller collaborative robots are often mounted onto a raised hardware platform or pedestal. These smaller industrial collaborative robots are often bolted onto a pedestal that, because of the amount of torque that they generate, is also bolted to the floor of the factory to ensure alignment. However, similar to the larger robots, these robots would also be in a fixed location and unable to be moved or redeployed.

Inherent in all robotic activity is the inertial moment introduced into the platform onto which the robot is mounted simply by the mechanical movement of the robotic arm. If the pedestal is not properly secured or anchored, the mechanical movement of the robotic arm is translated into movement of the pedestal as a reactionary force to the inertial forces of the robotic arm. Some significant lockdown or challenges to implementing a collaborative robot in a manufacturing environment include maintaining alignment and registration between the CNC machine (or other processing machine) and the centerline of the collaborative robot. Other challenges include maintaining alignment and registration between the centerline of the collaborative robot and the matrix tray that contains the raw material to be processed. Fractional movement of the pedestal must be prevented in order to maintain alignment between the CNC machine and the collaborative robot to allow for fault-free operation.

Currently, there are many robot pedestals available on the market. One example is an immobile pedestal configured to be secured directly to the floor of a machine shop, such as being bolted in place. However, collaborative robots often need to be moved to various locations around a machine shop, such as, for example, if a single collaborative robot is utilized in conjunction with multiple CNC machines or when access to a CNC machine is needed, making the immobile pedestal impractical.

Machinists need the ability to mount a collaborative robot onto a pedestal assembly in such a manner that allows a machine operator to move the robot out of the spindle access port to perform either machine tool maintenance on the machine or check the accuracy of a part. When done, the pedestal needs to be returned exactly to its original position in front of the machine maintaining registrations between the robot and the machine and the robot and the matrix tray. To address the mobility issue, pedestals having wheels thereon have been introduced. However, the location of a collaborative robot must be fixed in order to maintain an exact relationship between the robotic arm and the CNC machine. If a collaborative robot is not locked in place, inertial forces will fractionally move the pedestal resulting in misalignment between the robot and the workpiece located in the CNC machine and the accurately programmed robotic movement path for production use will be rendered useless. Feet may be added to the bottom of such pedestals to raise the wheels off the ground to prevent the pedestals from rolling while the robotic arm is in use. However, the height of the pedestal and the weight of the robotic arm make the entire pedestal-robot assembly top heavy. In addition, the large moment forces created by the robotic arm make the assembly vulnerable to tipping over. Additionally, in a manufacturing environment, if a liquid is spilled on the floor, such as machine coolant or lubricant, it may seep under the feet or casters thereby reducing the coefficient of friction between the floor and the pedestal. The reduced friction may allow the pedestal to slip out of alignment due to moment forces, human contact, vibration of the CNC machine, natural harmonic vibrations, or other forces.

In addition to being mobile, the pedestal must maintain a fixed position (x-y-z axes) during production in order to insure the robotic arm's ability to accurately pick up raw material and place it into a machine and then remove a finished part and place it in a matrix tray, repeatedly. To secure the pedestal from tipping over or being bumped out of alignment, L brackets have been added to the bottom of the pedestal so that the assembly may be bolted to the machine shop floor. However, oftentimes CNC machines are located in leased buildings and drilling into the concrete floor is prohibited. Most pedestals have two legs, a span between the two legs, and a riser which elevates the robot to the height of the machine bed for ease of access. Any pedestals with casters or feet do not have any anti-rotation (x-y-z) features to prevent movement. Especially features that allow it to be quickly released from the mounts and moved to a new location while keeping last know alignment.

Currently, there is not an existing solution to provide mobility and reliability without damaging the floor of a machine shop.

### SUMMARY OF THE INVENTION

In accordance with the present invention, systems and methods to facilitate the use of collaborative robots to tend metal fabrication equipment are provided. In one embodiment, a universal mount is provided that can be installed on a pedestal to secure a collaborative robot in a designated location. In various embodiments, the universal mount may provide the ability to move the pedestal that holds the collaborative robot away from a machine access door for redeployment or to allow machine maintenance or part inspection. In one embodiment, the universal mount may facilitate sliding the pedestal along a rail or set of rails from a first working position to a second position away from the working position. Prior to work commencing, the pedestal could then be slid along the rail(s) back to the first working position. In some embodiments, the rail(s) may include one or more alignment stops, detents, indentations, slots, markings, indicators or other securement points that may be established during an initial setup allowing the pedestal to be returned to a predetermined location, reducing the need to realign or calibrate the robot.

In another embodiment, the universal mount may facilitate pivotal and/or rotational movement of the pedestal around a fixed point or fulcrum secured to the machine and/or the floor. In some embodiments, the universal mount may include a riser step giving the operator greater reach inside of the machine. In this embodiment the robot and pedestal assembly may be affixed to a beam length (i.e., a lever arm) that pivots around a fulcrum. In some configurations, the use of a lever arm may reduce the effort or force required to move the robot assembly. In some embodiments, the fixed fulcrum may facilitate returning the robot assembly back to the original alignment position, thereby reducing the need for realignment or calibration.

In another embodiment, a universal mount may be provided for affixing the pedestal to the factory floor and/or attached to the machine frame. By attaching to the machine frame and/or using the machine frame for alignment, the variability in the relationship between the robot and machine may be reduced. In another embodiment, use of the universal mount may facilitate use of a pedestal having a low-profile design that may allow the robot to be located in close proximity to the machine and/or reduce the distance the legs of the pedestal extend out from the machine. Such an embodiment may allow the robot to have an extended reach, provide a step for an operator to access the active work holding area of the machine, improve safety by reducing the profile of the legs as an obstacle to the operator, and/or reduce the likelihood of accidental or inadvertent bumping of the assembly which could result in the misalignment of the robot.

In another embodiment, a parts presentation tray or matrix may be attached to the pedestal to maintain alignment registration between the robot and the location of the raw material to be machined and/or the location where the finished parts are to be placed. In some embodiments, the parts presentation tray may be integrated into the riser portion of the pedestal, attached to the riser portion, and/or secured to some other portion of the pedestal. Integration of the part presentation matrix with the pedestal removes the variability of the relationship between the robotic arm and the matrix, ensuring that the center-line of the robot arm remains aligned with the part presentation matrix before, during, and after movement.

In various embodiments, a method is provided to create a stable manufacturing robotic operational platform ecosystem. In various embodiments, the method may reduce or eliminate misalignment of the robot and the machine due to inadvertent movement of the pedestal; may reduce robot setup time after maintenance activity, may reduce x-y-z motion and/or rotation utilizing anti-rotation pins; may facilitate movement of the robot arm utilizing a low profile pedestal having a movable riser; may reduce misalignment by utilizing a low profile pedestal anchored to the floor or machine frame; may facilitate movement of the robot arm utilizing lockable casters to move the robotic pedestal mounting assembly from one predetermined location to another; and/or may include a parts presentation tray connected to the riser of the pedestal.

The above summary of the invention is not intended to represent each embodiment or every aspect of the present invention. Particular embodiments may include one, some, or none of the listed advantages.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates an embodiment of a universal anti-rotational floor mount attached to a pedestal having a robotic arm secured thereto;

FIG. 2 is a close up view of the universal anti-rotational floor mount of FIG. 1 secured to the pedestal;

FIG. 3 is a close up view of the universal anti-rotational floor mount of FIG. 1;

FIG. 4a is a connecting rod for cinching the robotic pedestal assembly to a stable position riser for use in an embodiment of the universal anti-rotational floor mount;

FIG. 4b is a semi-permanent floor pad for accepting the connecting rod of FIG. 4a for use in an embodiment of the universal anti-rotational floor mount;

FIG. 5 is a bottom perspective view of an embodiment of the universal anti-rotational floor mount having weep holes therein;

FIG. 6 is a flow chart of a method for utilizing an embodiment of a universal anti-rotational floor mount;

FIG. 7 is a perspective view of an embodiment of a pedestal having a part presentation tray mounted thereon and being slidable along a set of rails;

FIGS. 8a and 8b are top and bottom perspective views of the embodiment of a pedestal having a parts presentation tray attached thereto of FIG. 7;

FIG. 9 is a perspective view of the embodiment of a pedestal having a parts presentation tray attached thereto of FIG. 7 with an embodiment of a relatively low cost modifiable parts tray placed thereon;

FIG. 10 is a flow chart of a method for utilizing a modifiable parts tray; and

FIG. 11 is a flow chart of a method for integrating a collaborative robot and a CNC machine.

### DETAILED DESCRIPTION

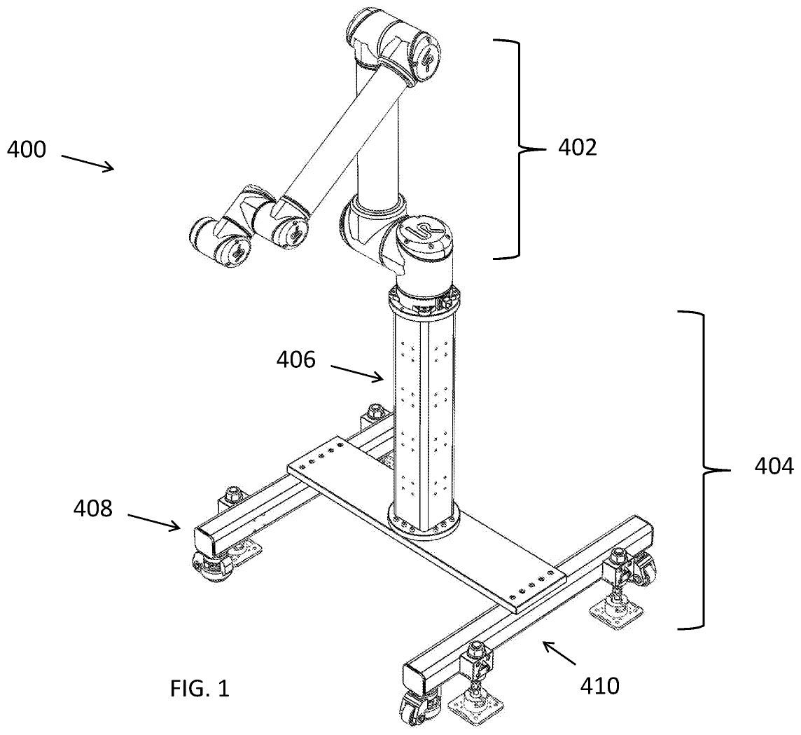

In accordance with the present invention, systems and methods to facilitate the use of collaborative robots are provided. Referring now to FIG. 1, collaborative robot assembly 400 is provided. The collaborative robot assembly 400 comprises a collaborative robot 402 mounted to a pedestal 404. In the embodiment shown, the pedestal 404 includes a riser 406 and legs 408. As can be seen in the embodiment shown, a universal anti-rotational floor mount 410 has been mounted to one of the legs 408. In various embodiments, a plurality of universal anti-rotational floor mounts 410 may be mounted to one or more legs 408 of the pedestal 404 depending on operational requirements. Although the pedestal in FIG. 1 is shown having two legs and a span therebetween, the universal anti-rotational floor mount may be attached to other types of pedestals having other configurations of legs, spans, extensions, wings, or other embodiments of bases secured to a robotic arm or other device needing to be maintained in a relatively stationary location for a period of time. In some embodiments, a single universal anti-rotational floor mount may be sufficient to secure the pedestal. In other embodiments, two or more universal anti-rotational floor mounts may utilized on the same side, opposite sides, or opposite corners of the pedestal.

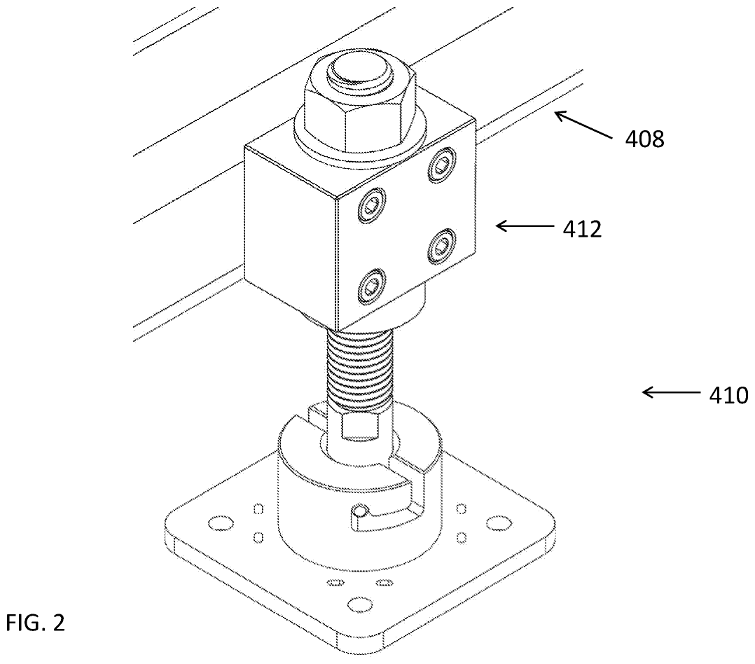

Referring now to FIG. 2, a close up view of the embodiment of the universal anti-rotational floor mount 410 of FIG. 1 is provided. As can be seen in the embodiment shown, the universal anti-rotational floor mount 410 has been secured to the leg 408 via four screws passing through the body 412 of the universal anti-rotational floor mount 410. In some embodiments, the body 412 may be permanently or removably secured to the leg 408 or other portion of the pedestal using any attachment method, including, but not limited to, screws, bolts, glue, epoxy, and/or welding. In some embodiments, the body 412 of the universal mount may be secured to a leg of the pedestal using U-bolts or other removable attachment rather than drilling into one or more of the legs 408.

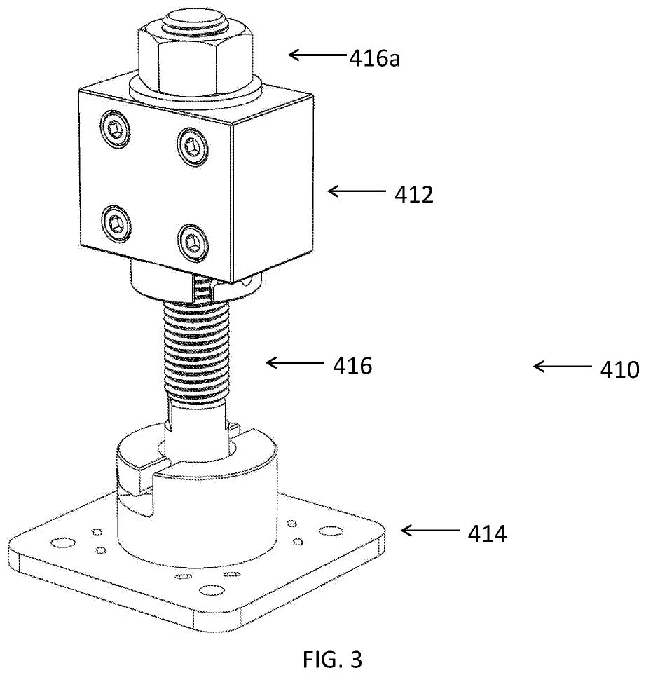

Referring now to FIG. 3, an embodiment of the universal anti-rotational floor mount 410 is shown unattached to the leg 408 of the pedestal 404. In the embodiment shown, the universal anti-rotational floor mount 410 comprises a body 412 having an anchor bolt 416 passing therethrough with a nut 416a secured to one end thereof and a foot plate receptacle 414 secured to the other end. In the embodiment shown, the foot plate 414 has a boss extending from an upper surface thereof and a spiral slot in a sidewall of the boss. In the embodiment shown, the leveling adjustment anchor bolt 416 has a portion that is threaded and a portion that is unthreaded. In some embodiments, the anchor bolt 416 may be entirely threaded or may have not threading. In some embodiments, the body 412 of the universal anti-rotational floor mount 410 may be integrally formed with the leg 408 of the pedestal. In some embodiments, a vertical hole may be drilled into a leg 408 of the pedestal to allow the anchor bolt 416 to pass therethrough.

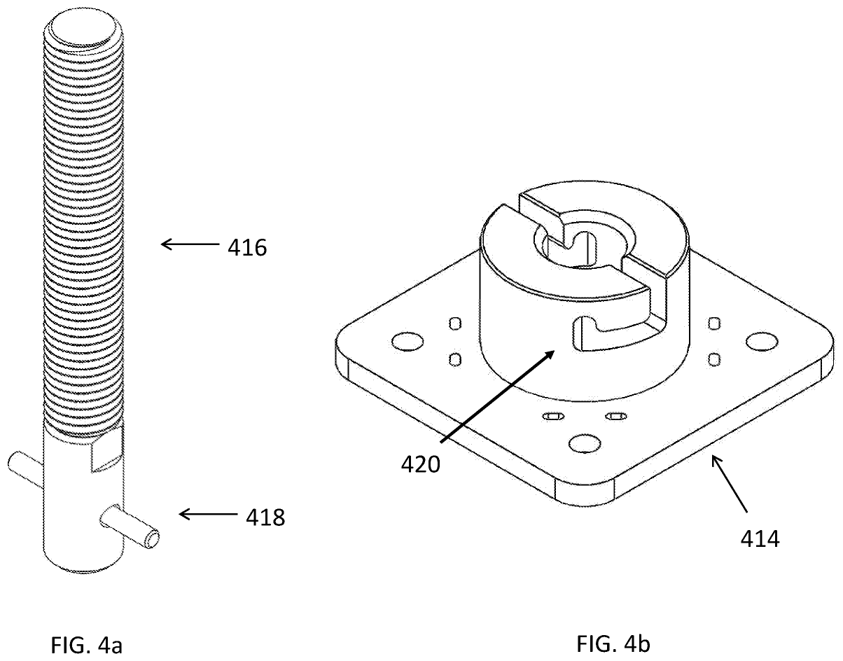

Referring now to FIGS. 4a and 4b, embodiments of the anchor bolt 416 and the foot plate receptacle 414 are shown. In the embodiment shown, the anchor bolt 416 has perpendicular protrusions 418, similar to the protrusions of a T-bolt, that may be configured to slide into a slot 420 in the foot plate receptacle 414. In various embodiments, to couple the anchor bolt 416 to the foot plate receptacle 414, the protrusions 218 are inserted into the slot 420 and the anchor bolt 416 is turned, for example, ninety degrees so that the protrusions 218 follow the slot 420 of the foot plate receptacle 414 until the protrusions 218 are located in a detent at the end of slot 420. Once coupled, the universal anti-rotational floor mount 410 may facilitate securing the pedestal from movement horizontally (x-y), vertically (z), and/or rotationally In other embodiments, the anchor bolt 416 and the slot 420 may be configured to allow turning of more or less than ninety degrees. In operation, the protrusions 418 of bolt 416 are held in the detent of slot 420 by an upward force. In some embodiments, tightening the nut 416a provides this upward force. In some embodiments, once the protrusions 218 are inserted into slot 420, tightening the nut 416a provides both the rotation and upward force for placing and holding the protrusions in the detent of slot 420. In some embodiments, the anchor bolt 416 may not include protrusions. In such embodiments, the anchor bolt 416 and the foot plate receptacle 414 may be threaded so that the anchor bolt 416 can be screwed directly therein. In some embodiments, the protrusions 418 of the anchor bolt 416 may comprise a threaded bolt and a t-not or a t-slot nut, rather than a pin passing through the anchor bolt 416 as shown in FIG. 4a. In some embodiments, an anchor bolt 416 having more or less than two protrusions may be utilized. In some embodiments, the anchor bolt 416 may have the same number of protrusions as the number of slots in the foot plate receptacle 414 or may have a different number. In some embodiments, the anchor bolt 416 may be inserted into a rail having a t-slot to allow the machine to slide along the rail and secured in place at one or more locations along the rail.

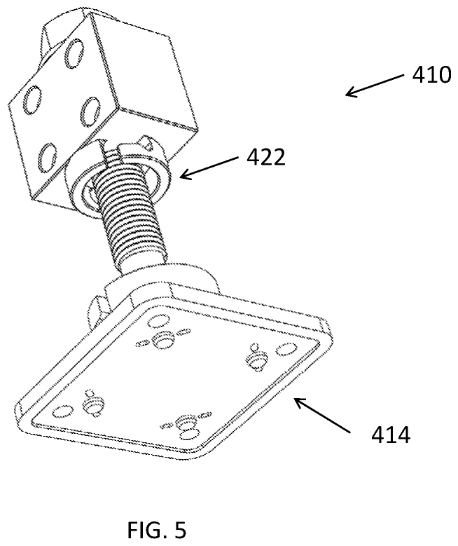

Referring now to FIG. 5, a lower perspective view of an embodiment of a universal floor mount assembly 410 is provided. In the embodiment shown, the foot plate 414 has raised edges around a perimeter thereof and holes therethrough. In operation, the holes may facilitate bolting the foot plate 414 directly to a floor and/or may act as weep holes to allow epoxy to pass therethrough and the raised edges may provide an area for epoxy to collect. In other embodiments, the anchor bolt 416 may be spring loaded. In some embodiments, the anchor bolt 416 may facilitate leveling of the pedestal by providing upward and/or downward forces to the legs of the pedestal, such as, for example, by utilizing a nut above and below the body of the universal mount. In some embodiments, each slot 420 may include one detent or a plurality of detents, wherein one or more detents are located on a upper surface of the slot 420 and/or one or more detents are located on a lower surface of the slot 420. In some embodiments, the hole through the body 412 of the universal mount 410 that receives the bolt 416 may be threaded to receive the threaded portion of the anchor bolt 416 or may be smooth to allow the bolt 416 to freely pass therethrough. In some embodiments, the anchor bolt 416 may have a hex key or other indention on a top thereof or may have a hole perpendicular therethrough to receive a pin to facilitate turning of the bolt 416 to couple the protrusions 418 with the slot 420. In some embodiments, the bottom of the body 412 may have a slot 422 similar to slot 420 adapted to receive the protrusions 418 therein to hold the anchor bolt 416 in an up position when not in use. In some embodiments, nut 416a may facilitate maintaining the anchor bolt 416 in an up-position when not in use.

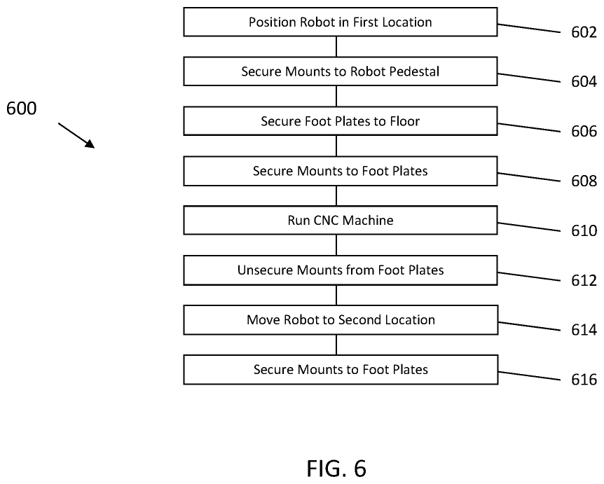

Referring now to FIG. 6, a flowchart is provided for a method 600 of utilizing a universal mount to facilitate the use of collaborative robots to tend metal fabrication equipment. At step 602, a pedestal having a collaborative robot mounted thereon is positioned in a first location. The first location may be in close proximity to the access door of a metal fabrication machine. In embodiments where the universal mounts are not already secured to the pedestal, at step 604, one or more universal mounts may be secured to the legs of the pedestal. In some embodiments, it may be beneficial to position the pedestal in the first location in order to determine optimal locations for the universal mounts based on operational requirements, such as the characteristics of the floor below the pedestal, the torque produced by the robotic arm, and other factors. Next, at step 606, the foot plates of the universal mounts are secured to the floor of the machine shop. In some embodiments, the foot plates may be bolted down, whereas in other embodiments, the foot plates may be glued, epoxied, or secured in one or more other ways. If the foot plates are already secured to the body of the universal mounts, the robotic arm may be utilized to tend the CNC machine or other equipment. If the pedestal has been moved, either during the securing of the foot plates to the floor or for use elsewhere, then at step 608, the body of the universal mounts may be secured to the foot plates. As explained in more detail below, once the collaborative robot is secured in the first location, the robot may be programmed to tend the CNC machine or perform other tasks at step 610. After the collaborative robot has completed the tending of the CNC machine or other assigned task, the bolts of the universal mount may be uncoupled from the foot plates at step 612 and the collaborative robot may then be moved to a second location at step 614. If the robot was moved to facilitate maintenance or other task on the equipment the robot was tending, the robot can then be returned to the first location and secured again to the foot plates at step 616. In other embodiments, if the robot is to perform a task at the second location, additional foot plates can be secured to the floor corresponding to the locations of the universal mounts relative to the second location. In such an embodiment, the collaborative robot could be moved between two or more locations and, once secured to the foot plates at such locations, could begin performing tasks. By securing the body of the universal mounts to the foot plates at the various locations, the need to recalibrate the unit and/or the amount of recalibration needed after each move may be reduced. In some embodiments, a plurality of foot plates may be secured in front of a single machine to facilitate swapping a first pedestal with a second pedestal.

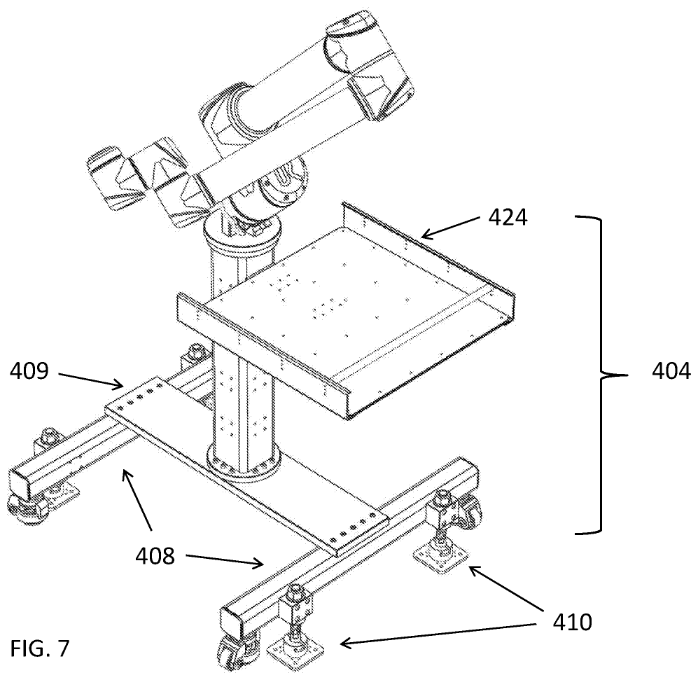

Referring now to FIG. 7, in an alternative embodiment, the universal mount 410 may facilitate sliding the pedestal 404 along a rail or set of rails from a first working position to a second position away from the working position. In the embodiment shown, legs 408 include a rail or t-slot along an upper surface thereof and the span 409 includes protrusions or t-bolts on a bottom surface thereof that slidingly engage the rail on the legs 408. Prior to work commencing, the riser portion of the pedestal 404 could be slid along the rail(s) back to the first working position. In some embodiments, the rail(s) may include one or more alignment stops, detents, indentations, slots, markings, indicators or other securement points that may be established during an initial setup allowing the riser of the pedestal to be returned to a predetermined location, reducing the need to realign or calibrate the robot. As explained in more detail below, the pedestal 404 shown in FIG. 7 also includes a parts presentation tray 424 mounted to the riser portion of the pedestal 404.

In some embodiments, the universal mount may facilitate pivotal and/or rotational movement of the pedestal around a fixed point or fulcrum secured to the machine and/or the floor. In some embodiments, the universal mount may include a riser step giving the operator greater reach to inside of the machine. In this embodiment, the robot and pedestal assembly may be affixed to a beam length (i.e., a lever arm) that pivots around a fulcrum. In some configurations, the use of a lever arm may reduce the effort or force required to move the robot assembly. In some embodiments, the fixed fulcrum may facilitate returning the robot assembly back to the original alignment position, thereby reducing the need for realignment or calibration.

In other embodiments, a universal mount may be provided for affixing the pedestal to the factory floor and/or to the machine frame. By attaching to the machine frame and/or using the machine frame for alignment, the variability in the relationship between the robot and machine may be reduced. In another embodiment, use of the universal mount may facilitate use of a pedestal having a low-profile design that may allow the robot to be located in close proximity to the machine and/or reduce the distance the legs of the pedestal extend out from the machine. Such an embodiment may allow the robot to have an extended reach, provide a step for an operator to access the active work holding area of the machine, improve safety by reducing the profile of the legs as an obstacle to the operator, and/or reduce the likelihood of accidental or inadvertent bumping of the assembly which could result in the misalignment of the robot.

In various embodiments, a method is provided to create a stable manufacturing robotic operational platform ecosystem. In various embodiments, the method may reduce or eliminate misalignment of the robot and the machine due to inadvertent movement of the pedestal; may reduce robot setup time after maintenance activity, may reduce x-y-z movement and rotation utilizing anti-rotation pins; may facilitate movement of the robot arm utilizing a low profile pedestal having a movable riser; may reduce misalignment by utilizing a low profile pedestal anchored to the floor or machine frame; may facilitate movement of the robot arm utilizing lockable casters to move the robotic pedestal mounting assembly from one predetermined location to another; and/or may include a parts presentation tray connected to the riser of the pedestal.

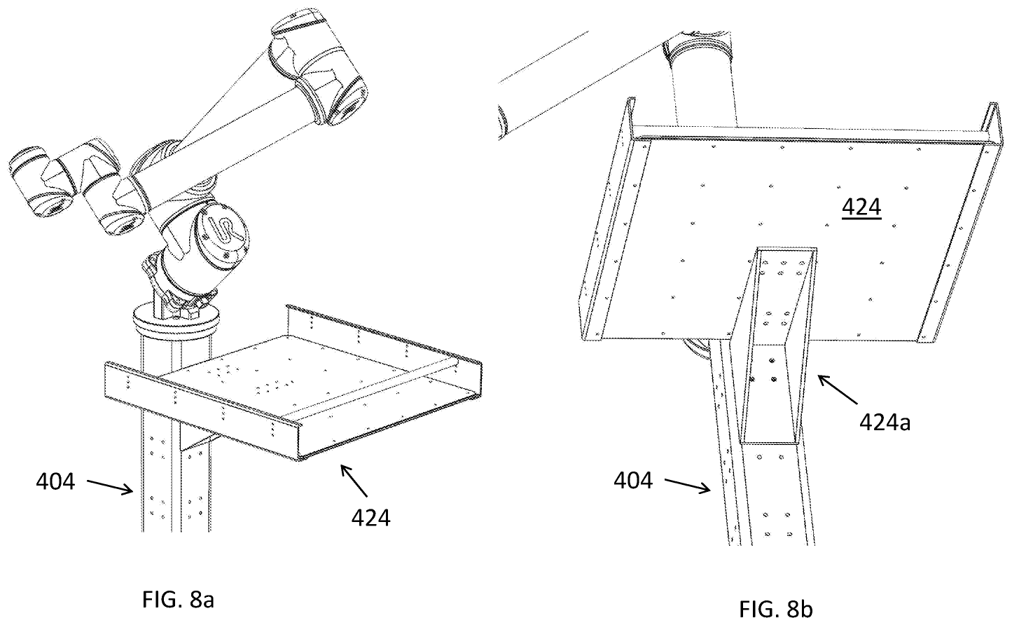

Referring now to FIGS. 8a and 8b, top and bottom perspective views of an embodiment of a pedestal 404 having a parts presentation tray or matrix 424 attached to a riser portion of the pedestal 404 is shown. By mounting the parts tray 424 directly to the pedestal 404, alignment registration between the robot and the location of the raw material to be machined and/or the location where the finished parts are to be placed is increased. In some embodiments, the parts presentation tray 424 may be integrated into the riser portion of the pedestal 404, attached to the riser portion, and/or secured to some other portion of the pedestal 404. Integration of the part presentation tray 424 with the pedestal 404 removes the variability of the relationship between the robotic arm and the parts presentation tray 424, ensuring that the center-line of the robot arm remains aligned with the parts presentation tray 424 before, during, and after movement. As shown in FIG. 8b, a support bracket 424a may be used to secure the parts presentation tray 424 to the pedestal 404. In various embodiments, the parts presentation tray 424 may be secured to the riser of the pedestal 404 at a plurality of locations. For example, if larger parts are being manufactured, the parts presentation tray 424 could be lowered and then if smaller parts are being manufactured, the parts presentation tray 424 could be raised. In some embodiments, the parts presentation tray 424 could be secured at predetermined locations corresponding to pre-programmed locations. Such an embodiment may reduce the amount of recalibration required when moving the parts presentation tray 424 relative to the robotic arm. In other embodiments, the parts presentation tray 424 may be extendible outwardly from the riser or offset to one side or the other.

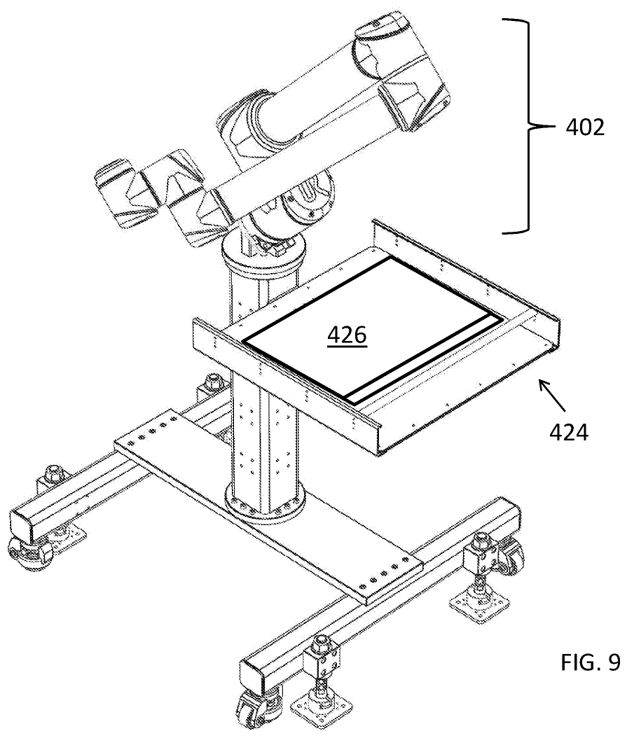

Referring now to FIG. 9, the parts presentation tray 424 is shown with an embodiment of a modifiable parts matrix 426 secured thereon. In the embodiment shown, the modifiable parts matrix 426 may include a foam base or other material secured to the parts presentation tray 424. The robotic arm 402 may be programmed to create impressions and/or slots in the modifiable parts matrix 426 where the raw material will be placed. The impressions may be made using a blank, such as a workpiece of the starting raw material. The same process can be used to create a parts matrix 426 for the final product. In some embodiments, the impressions and/or slots in the modifiable parts matrix 426 may be shaped to facilitate the placement of both the starting raw material and the final product. In some embodiments, the density and other physical characteristics of the foam or other material used to form the modifiable parts matrix 426 may be varied depending on the product specifications. For example, for smaller or more fragile products, the foam may be less dense and easier to punch slots into. For larger products, the foam or other material may be thicker and/or denser.

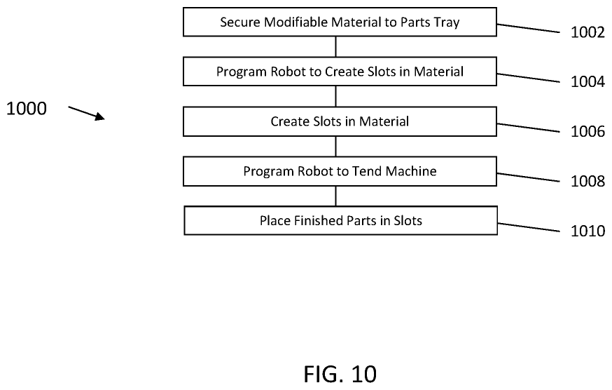

Referring now to FIG. 10, a method 1000 for utilizing a modifiable material in conjunction with a collaborative robot is provided. At step 1002, a modifiable material, such as a virgin foam block, is secured to the parts presentation tray. At step 1004, the collaborative robot may be programmed in a first mode of operation to pick up a punching tool or starting raw material and, at step 1006, punch slots or impressions in the foam at predetermined locations. At step 1008, the robotic arm may be programmed in a second mode of operation to pick up finished products and, at step 1010, place them back into the predetermined locations or into another custom designed tray. In some embodiments, the prototype or punching tool may be a finished product. In some embodiments, the dimensions of the finished product may be entered into the program and the robot may be programmed to optimize the predetermined locations. In some embodiments, the location of the parts presentation tray may be on the riser or on the rails or legs of the hardware support platform and the thickness or other characteristics of the foam base may be entered into the program and the robot may be programmed to utilize the entered information to create slots and/or place completed parts in the foam. In some embodiments, the parts presentation tray and/or modifiable parts matrix may be located on a workbench or other surface in proximity to the robot.

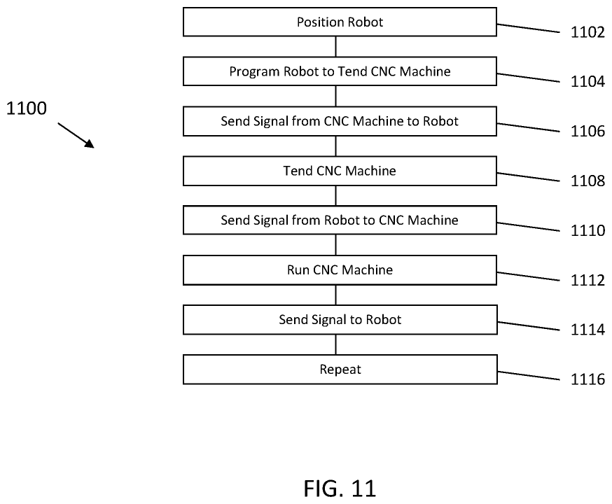

Referring now to FIG. 11, a method 1100 for utilizing a collaborative robot to tend a CNC machine is provided. At step 1102, a collaborative robot is positioned proximate to an access door of a CNC machine. In various embodiments, the collaborative robot may be secured in that location utilizing the universal anti-rotation, cinching floor mount receptacles described above. At step 1104, the collaborative robot may be programmed to tend the CNC machine or other metal fabricating equipment. At step 1106, a signal may be sent from the CNC machine (or other machine) to the collaborative robot indicating that the machining process is completed and the finished part is ready to be retrieved. At step 1108, the collaborative robot performs its programmed tasks which may include, but is not limited to, reaching into the work area of the CNC machine to retrieve a finished part and place it on a parts tray, preparing the CNC machine to machine another part such as expelling air or liquid to blow any undesired particulate or performing other steps, necessary to ensure that the space between the jaws on the clamping vice on the pallet is free from debris. This is followed by retrieving a new raw part and placing it in the work area of the CNC machine. At step 1110, a signal is sent from the robot to the CNC machine indicating to the CNC machine that the robotic tending has been completed and that the process for machining the next raw part may begin. At step 1112, the CNC machine runs its programmed operation and, at step 1114, sends a signal to the collaborative robot that the machining process is finished. This process is repeated until all the parts have been milled. In some embodiments, a separate controller may be installed to receive the signals from the CNC machine and the collaborative robot that their respective processes are finished and to send the signals to the CNC machine and the collaborative robot to begin their respective processes. The process may repeat at step 1116. In some embodiments, the controller may need to allow both automated processes and manual processes. For example, if the collaborative robot is tending the CNC machine, the opening and closing of the access door to the CNC machine needs to be automated. However, during maintenance or if a human is tending the CNC machine, a manual override button may be needed to allow the human to open and close the access door.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications, and substitutions without departing from the spirit and scope of the invention.

What is claimed is:

1. An anchor mounting assembly for securing an object to a surface, comprising:
a base plate configured to be secured to a surface, the base plate having a boss extending from an upper surface thereof, the boss having one or more elongated slots in a sidewall thereof;
an anchor bolt having a threaded portion at one end and one or more protrusions extending outwardly from an opposite end;
an anchor body configured to be attached to an object, the anchor body having an aperture sized to receive the threaded portion of the anchor bolt;
the base plate being configured such that when the anchor bolt is inserted into the boss, the one or more protrusions slide into the one or more elongated slots;
the one or more elongated slots being configured such that when the anchor bolt is rotated relative to the base plate from a first position through a predetermined angle of rotation to a second position, the one or more protrusions follow the one or more slots in the sidewalls as the anchor bolt rotates; and
a nut configured to be threadably secured to the threaded portion of the anchor bolt, such that when the one end of the anchor bolt is inserted through the anchor body and the opposite end of the anchor bolt is inserted into the boss, tightening the nut raising the anchor bolt so that the one or more protrusions press against detents in an upper surface of the elongated slots to prevent movement of the anchor bolt relative to the base plate.

2. The anchor mounting assembly of claim 1, wherein there are two circumferentially spaced protrusions on the anchor bolt.

3. The anchor mounting assembly of claim 1, wherein the base plate is secured to the surface using epoxy.

4. The anchor mounting assembly of claim 1, wherein a lower surface of the base plate includes a raised perimeter and weep holes therethrough.

5. The anchor mounting assembly of claim 1, wherein an anchor body is secured to a pedestal coupled to a robotic arm.

6. The anchor mounting assembly of claim 1, wherein tightening the nut rotates the anchor bolt from the first position to the second position.

7. A mounting system for securing a pedestal to a floor comprising:
an anchor bolt having a threaded portion on a first end and two protrusions extending outwardly from a second end;
an anchor body configured to be mounted to a pedestal, the anchor body having an aperture configured to allow the first end of the anchor bolt to be inserted therethrough;
a nut having threads on an inner surface thereof and configured to be threadably secured to the threaded portion of the anchor bolt;
a mounting plate configured to be secured to a surface, the mounting plate having a boss extending from an upper surface thereof, the boss having a circular sidewall with two non-linear slots formed therein configured to receive the two protrusions of the anchor bolt;
wherein tightening the nut causes the anchor bolt to rotate relative to the mounting plate until the two protrusions engage detents on an upper surface of the two non-linear slots.

8. The mounting system of claim 7, wherein the mounting plate has a raised surface around a perimeter thereof.

9. The mounting system of claim 7, wherein the mounting plate includes a plurality of weep holes therethrough.

10. The mounting system of claim 7, wherein the two protrusions engaging the two non-linear slots form pin-and-slot connections.

11. The mounting system of claim 7, wherein the anchor bolt is a T-bolt.

12. The mounting system of claim 7, wherein the anchor body is mounted to a pedestal coupled to a robotic arm.

13. The mounting system of claim 7, wherein the anchor body includes a boss extending from a lower surface thereof having a circular sidewall with two non-linear slots formed therein configured to receive the two protrusions of the anchor bolt.

14. An apparatus comprising:
a mounting plate configured to be secured to a surface, the mounting plate having a raised collar with two elongated slots in a sidewall thereof, the elongated slots having detents at ends thereof;
an anchor bolt having upper and lower portions, the upper portion having external threads and the lower portion having a cross bar adapted to be positioned in the elongated slots when the lower portion of the anchor bolt is inserted into the raised collar;
a mounting body having an aperture therein sized to receive the upper portion of the anchor bolt; and
an internally threaded nut adapted to threadably engage the external threads on the upper portion of the anchor bolt to apply an upward force to the anchor bolt so that the cross bar engages the detents at the ends of the elongated slots.

15. The apparatus of claim 14, wherein the mounting plate is secured to the surface with epoxy.

16. The apparatus of claim 14, wherein the mounting plate is secured to the surface with screws.

17. The apparatus of claim 14, wherein the wherein the mounting body is mounted to a pedestal coupled to a robotic arm.

18. The apparatus of claim 14, wherein the mounting body includes a boss extending from a lower surface thereof having a circular sidewall with two non-linear slots formed therein configured to receive the two cross bar of the anchor bolt.

19. The apparatus of claim 14, wherein the anchor bolt is a T-bolt.

20. The apparatus of claim 14, wherein the mounting body is integrally formed with a pedestal coupled to a robotic arm.
